(19) United States
(12) Patent Application Publication
(10) Pub. No.: US 2021/0185995 A1
(43) Pub. Date: Jun. 24, 2021

(54) FISHING LURE STORAGE AND ORGANIZATION SYSTEM

(71) Applicant: Douglas H. Morash, Grand Island, NY (US)

(72) Inventor: Douglas H. Morash, Grand Island, NY (US)

(21) Appl. No.: 16/723,007

(22) Filed: Dec. 20, 2019

(51) Int. Cl. A01K 97/06; B65D 25/04; B65D 25/10

(52) U.S. Cl. CPC A01K 97/06; B65D 25/108; B65D 25/04

(57) ABSTRACT

A fishing lure storage and organization system comprises multiple cards that are hingedly fitted in a fishing tackle box to segregate crankbaits, spoons and hooks. The cards have incrementally spaced-apart niches at the top edge. The niches organizationally retain a primary hook of a spoon or crankbait. The card also has tapered card-holes disposed in a vertical arrangement. A spacer extends perpendicularly from the card, providing separation between cards. An axle extends laterally from the bottom sidewall of card to mate with holes in the sidewall of tackle box, allowing the card to swivel inside tackle box for viewing and easy access to lures. Partitions segregate the lures on card. Partitions have flat surfaces with parallel flanges that detachably couple to tapered holes in the card. A tapered dovetail junction and a separated dovetail junction on the card slidably mate with corresponding tapered partitions to create a snug fit therebetween.

### FIELD OF THE INVENTION

The present invention relates generally to a fishing lure storage and organization system. More so, the present invention relates to an organization system that includes multiple cards hingedly fitted in a fishing tackle box, and defined by incrementally spaced-apart niches at their top edges configured to organizationally retain a primary hook from a spoon lure and/or a crankbait lure, and also defined by tapered card-holes disposed in a vertical arrangement; whereby the card further comprises at least one spacer extending perpendicularly from the face of the card to provide separation between multiple cards that are arranged in sequence inside the fishing tackle box, and at least one axle extending laterally, coplanar from the bottom edge of the card to enable pivotable coupling with the fishing tackle box; and further includes at least one partition configured to couple to the tapered card-holes for vertical segregation of the lures on the card. A tapered dovetail junction and a separated dovetail junction on the card slidably mate with corresponding tapered partitions to create a snug fit therebetween.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, anglers use multiple lures of different types and need a convenient method of organizing, storing, and carrying them. Shore and small boat anglers struggle with tight space constraints and would benefit greatly from a compact and flexible storage device which allows the angler to customize his lure storage for his particular needs. Many existing lure storage devices generally are oriented towards a single type of lure (i.e. spoons and/or crankbaits), which forces the angler to use two storage devices which exacerbates his space constraints. It is also recognized that the more universal flat box storage devices are not very volume efficient and when storing multiple lures can produce significant hook tangles.

Other proposals have involved organizing systems for fishing tackle boxes. The problem with these organizing systems is that they do not have the ability to customize the tackle storage system according to the angler's needs and wants in a space efficient tangle free manner . . . . Even though the above cited organizing systems for fishing tackle boxes meet some of the needs of the market, a fishing lure storage and organization system that includes multiple cards hingedly fitted in a fishing tackle box, and defined by incrementally spaced-apart niches at their top edges configured to organizationally retain a primary hook from a spoon and/or a crankbait, and has the means to efficiently organize the angler's lures in a customizable tangle free configuration is a significant improvement.

### SUMMARY

Illustrative embodiments of the disclosure are generally directed to a fishing lure storage and organization system. The fishing lure storage and organization system comprises multiple cards that are hingedly fitted in a fishing tackle box to segregate at least one spoon and at least one crankbait, and especially the multiple hooks thereof. The cards are defined by multiple incrementally spaced-apart niches at the top edge. The niches are configured to organizationally retain a primary hook from a spoon and/or a crankbait.

The card is also defined by multiple tapered card-holes disposed in a vertical arrangement. The card further comprises at least one spacer that extends perpendicularly from the face of the card to provide separation between multiple cards arranged in card-file sequence inside the fishing tackle box.

The cards also comprise at least one axle that extends laterally, coplanar from the bottom edge of the card. The axle mates with holes in the side of the tackle box, which allows the card to swivel on an axis in the inner surface of the tackle box, so as to provide an angled view and an easy access of the lures, while also retaining the card in a vertical, upright position.

The system also includes at least one partition that detachably attaches to the tapered card-holes of the card. The partitions work to vertically segregate the lures on the card. The partition is defined by a flat surface with multiple parallel flanges extending perpendicularly from one edge. The flange couples to the tapered holes in the card. The partition can be selectively inserted or removed from the card, depending on the needs of the angler. The partitions allow the tackle box to be customized by the angler to be a spoon box, a crankbait box, or some combination of spoon/crankbait box. The upright, vertical disposition of the card having removable partitions prevent the hooks on the crankbaits from tangling. In one alternative embodiment, a tapered dovetail junction and a separated dovetail junction on the card slidably mate with corresponding tapered partitions to create a snug fit therebetween.

One objective of the present invention is to organize multiple spoons and crankbaits in a fishing tackle box.

Another objective is to store and organize lures, so as to allow the angler to store all his go-to lures and combine them according to his needs in a single convenient box.

An exemplary objective is to provide a card/partition concept that is scalable, space efficient, flexible, tangle-free, and highly adaptable.

Yet another objective is to securely hold the primary hooks of the spoon and crankbait in the niches along the top edge of the card.

An exemplary objective is to vertically segregate the lures with at least one partition

Additional objectives are to provide a card-style lure segregation system that is operational inside a fishing lure box.

Another objective is to attach and detach the partitions from the face of the card in a quick-snap manner.

Yet another objective is to provide an inexpensive to manufacture card of a fishing tackle box.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary fishing lure storage and organization system, showing rear face of a card, in accordance with an embodiment of the present invention;

FIG. 2 illustrates a perspective view of the fishing lure storage and organization system, showing partitions coupled thereto, in accordance with an embodiment of the present invention;

FIG. 3 illustrates a front view of the fishing lure storage and organization system, showing partitions coupled thereto, in accordance with an embodiment of the present invention;

FIG. 4 illustrates a rear view of the card, showing tapered card-holes, and a detailed view of a tapered card-hole, in accordance with an embodiment of the present invention;

FIG. 5 illustrates a rear view of the card, showing the tapered card-holes in FIG. 4 with a flange that forms a partition coupled thereto, in accordance with an embodiment of the present invention;

FIG. 6 illustrates a perspective side view of an exemplary partition, in accordance with an embodiment of the present invention;

FIGS. 7A-7C illustrate a partition having a tapered connector and a tapered flange, where FIG. 7A shows an elevated side view of the partition, FIG. 7B is a cross-sectional, taken generally along line B-B in FIG. 7C of the tapered connector and flange and FIG. 7C shows a close-up of a side view of the tapered connector in accordance with an embodiment of the present invention;

FIGS. 8A-8I illustrate an alternative embodiment of a card and a tapered partition configured to join at a tapered dovetail joint that fully extends from the top edge to the bottom edge of the card for coupling to a corresponding tapered partition, whereby FIG. 8A shows a perspective view of the card receiving the partition, FIG. 8B shows an elevated side view of the partition having a wide end and a narrow end, FIG. 8C shows a frontal view of the tapered partition, FIG. 8D shows a narrow end of the tapered partition, FIG. 8E shows the junction between the narrow end of the tapered junction and the tapered dovetail joint, FIG. 8F shows a cross-sectional of tapered dovetail joint at an angle of F°, taken generally along line H-H in FIG. 8C of the tapered partition, FIG. 8G shows a front view of the card with multiple tapered dovetail joints with each dovetail joint configured in a non-parallel arrangement from narrow to wide, so as to accommodate a corresponding tapered partition, FIG. 8H shows a cross-sectional of the card, taken generally along line A-A in FIG. 8G, and FIG. 8I shows a detailed view of the tapered dovetail joint from FIG. 8H, in accordance with an embodiment of the present invention;

FIGS. 9A-9I illustrate an alternative embodiment of a card and a tapered partition configured to join at a separated tapered dovetail joint having a wide section at the top edge of the card, and a narrow section at the bottom edge of the card for coupling to a corresponding tapered partition, whereby FIG. 9A shows a perspective view of the card receiving the partition, FIG. 9B shows a front view of the card with multiple separated tapered dovetail joints having a wide section at the top edge of the card, and a narrow section at the bottom edge of the card for coupling to a corresponding tapered partition, FIG. 9C shows a cross-sectional of the card, taken generally along line N-N in FIG. 9B, FIG. 9D shows a detailed view of the separated tapered dovetail joint from FIG. 9C at an angle of C°, FIG. 9E shows an elevated side view of the partition having a wide end and a narrow end, FIG. 9F shows a frontal view of the tapered partition, FIG. 9G shows a narrow end of the tapered partition at an angle of P°, FIG. 9H shows the junction between the narrow end of the tapered junction and the separated tapered dovetail joint, and FIG. 9I shows a cross-sectional of separated tapered dovetail joint, taken generally along line S-S in FIG. 9F of the tapered partition, in accordance with an embodiment of the present invention; and

FIG. 10 illustrates a top view of an exemplary container with multiple cards operational therein, and retaining a spoon and crankbaits, in accordance with an embodiment of the present invention.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments.

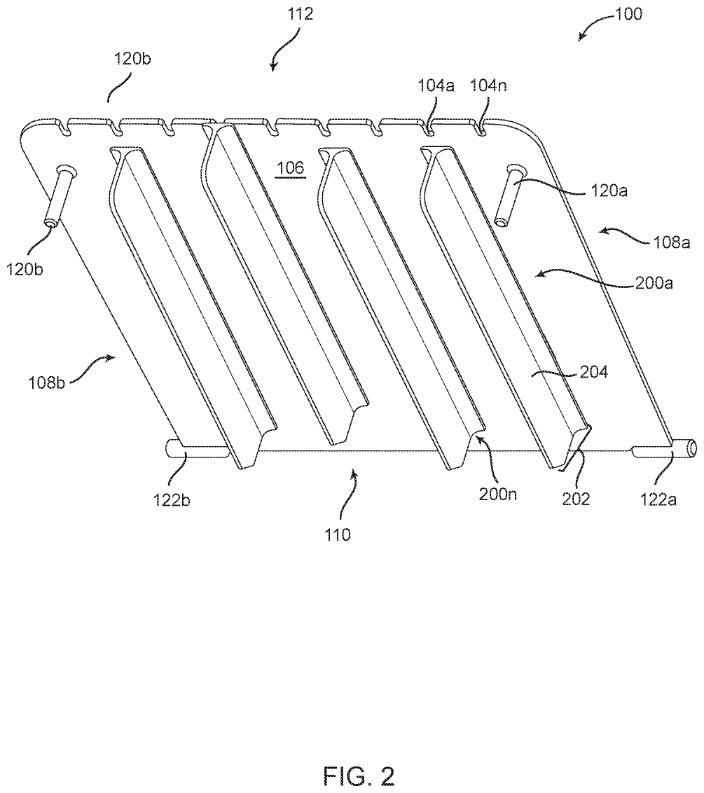

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 2. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

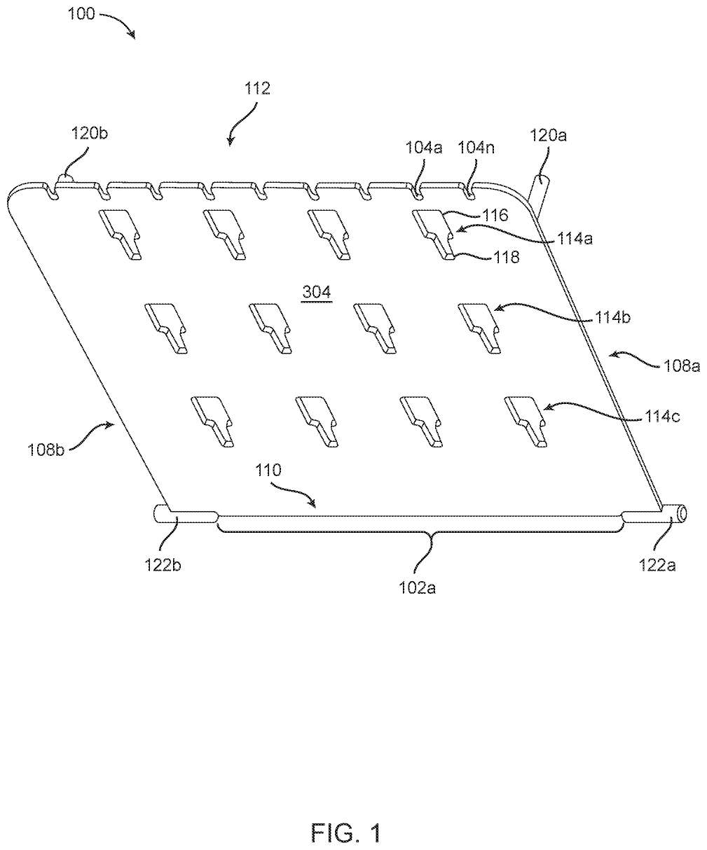

A fishing lure storage and organization system 100 is referenced in FIGS. 1-10. Fishing lure storage and organization system 100, hereafter “system 100”, is a unique organizer that is operational inside a fishing tackle box to easily separate, view, and access lures. In one example, multiple cards 102a-n serve organization/segregation means, inside a fishing tackle box, to help prevent lure hooks and other potentially tangling components inside the fishing tackle box from tangling, or getting lost. Cards 102a-n are especially effective for segregating a spoon 1012 having a primary hook 1016a and a crankbait 1014 having primary hook 1016b and at least one secondary hook 1016c-d.

As referenced in FIG. 1, system 100 utilizes multiple cards 102a-n that work in an adjacent, parallel, card-organizer configuration to segregate the various types of lures, including the spoon 1012 having a primary hook 1016a; and the crankbait 1014 having both primary 1016b and secondary hooks 11016c, 1016d. Cards 102a-n are defined by a front face 106 and an opposing rear face 304. Front face 106 is oriented towards a front side of a container 1000, such as a fishing tackle box when lures are contained therein.

Continuing with FIG. 2, cards 102a-n are also defined by a pair of side edges 108a, 108b, a top edge 112, and an opposing bottom edge 110. Top edge 112 is oriented upwardly, visible and proximal to the user of the system 100. When contained in container 1000, discussed below, bottom edge 110 rests on floor of container 1000, while side edges 108a, 108b orient towards the sidewalls 1002a-b of container 1000. In one non-limiting embodiment, cards 102a-n are defined by a flat, rectangular shape. Though in other embodiments, different shapes and dimensions may also be used for cards 102a-n, as long as the dimensions enable segregation and retention of fishing lures. In other embodiments, cards are transparent.

In some embodiments, system 100 provides at least one axle 122a, 122b that extends laterally, and coplanar from the side edges 108a, 108b of card. Axle 122a, 122b is proximal to the bottom edge 110 of the sidewalls 108a-b (See FIG. 1). Axle 122a, 122b allows cards 102a-n to pivotally couple to apertures 1010a, 1010b forming in sidewalls 1002a-b of container 1000, so that cards 102a-n can be pivoted to view contents of lures in container 1000. In one non-limiting embodiment, the at least one axle 122a, 122b comprises a pair of opposing, elongated cylinders.

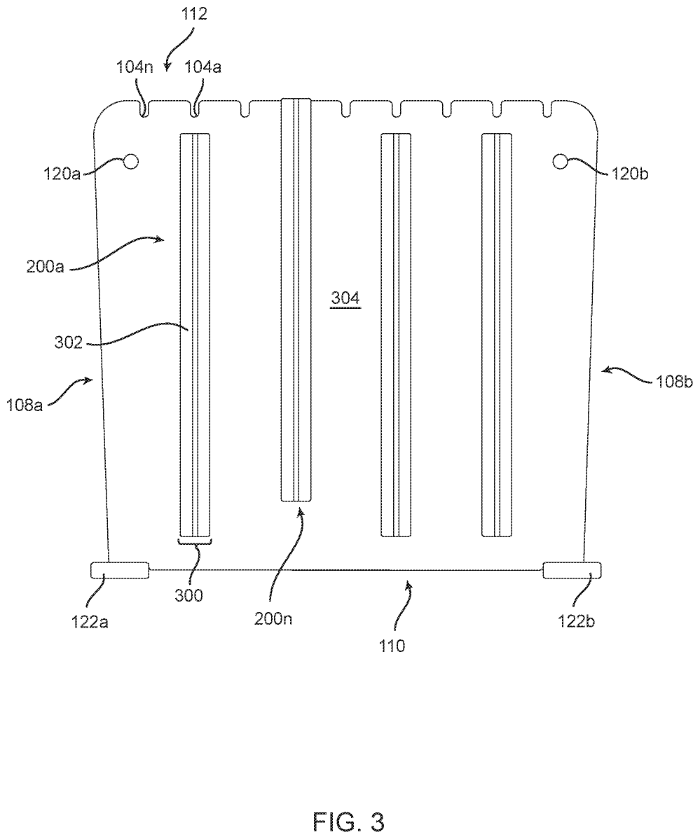

As illustrated in FIG. 3, top edge 112 of cards 102a-n forms multiple, spaced apart niches 104a-n. Niches 104a-n may run completely across top edge 112, creating a space of 1-5 mm between each niche. However, since system 100 is scalable other dimensions may also be used. Niches 104a-n are sized and dimensioned to retain a primary hooks 1016a and 1016b from a spoon 1012, or a crankbait 1014, or both. The recessed configuration of the niche provides a natural position for a hook from the lures 1012, 1014.

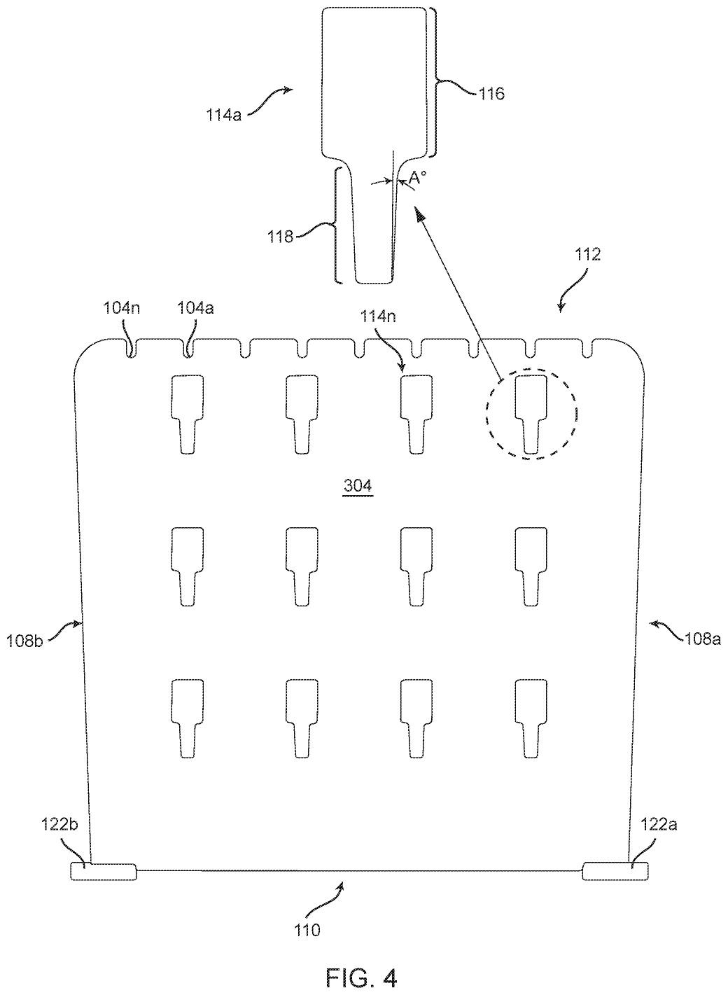

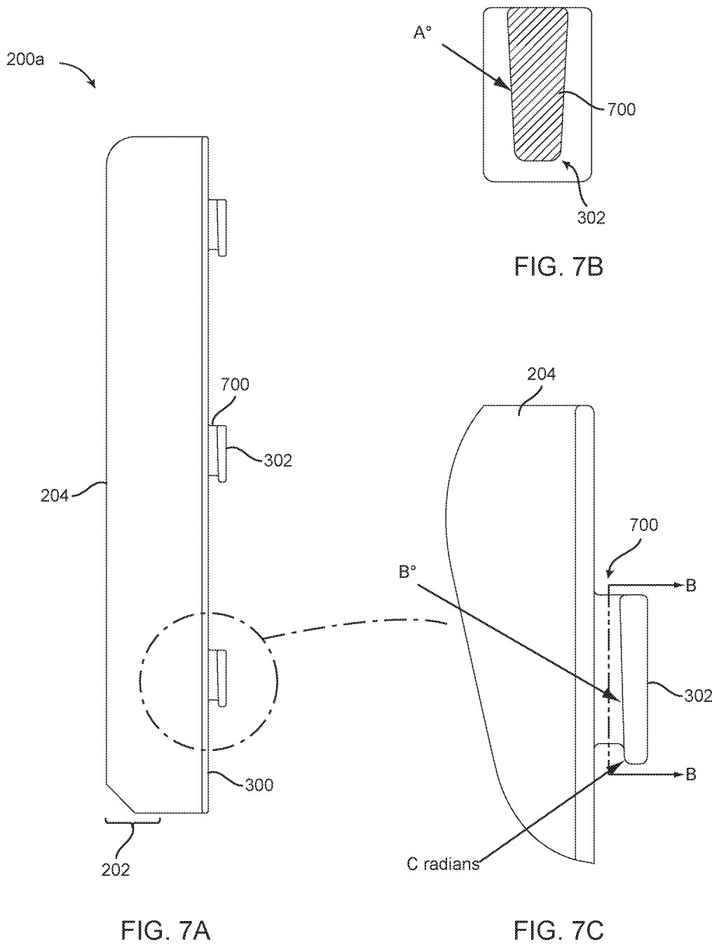

Looking now at FIG. 4, faces 106, 304 of cards 102a-n are defined by multiple tapered card-holes 114a-n. Card-holes 114a-n are utilized for securing at least one partition 200a-n, discussed below. Tapered card-holes 114a-n are disposed in an aligned, vertical arrangement from the top edge 112 to the bottom edge 110. The tapered card-holes 114a-n are defined by a wide end 116 and an opposing narrow end 118. The wide end 116 is oriented towards the top edge 112 of the cards 102a-n. Opposing narrow end 118 of tapered card holes 114a-n have an acute angle A° that is designed to create a friction-fit coupling effect between tapered connector 700 as shown in FIGS. 7A-C.

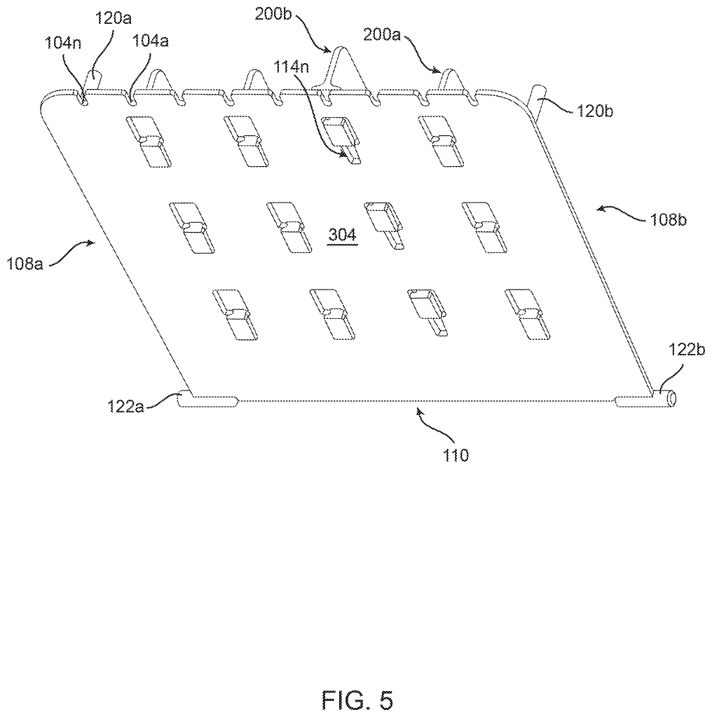

FIG. 5 further illustrates a rear view of the card, showing the tapered card-holes in FIG. 4 with a flange that forms a partition coupled thereto. FIG. 5, illustrates a system 100 that provides at least one spacer 120a, 120b that extends perpendicularly from the front face 106 of the card. Spacer 120a, 120b is configured to extend from front face 106 of card 102a, and engage an adjacent rear face 304 of an adjacent, more forward-positioned card 102n. In this manner, spacer 120a, 120b creates space between cards 102a-n. This spacing capacity allows for facilitated viewing, and easier access to lures 1012, 1014 contained in container 1000. In one non-limiting embodiment, the at least one spacer 120a, 120b comprises two elongated, cylindrical-shaped tabs. However, in other embodiments, differently shaped spacers, and different numbers of spacers may also be used. FIG. 5 further shows how flange 302 engages the tapered card-holes 114a-n in a snug, slidable relationship.

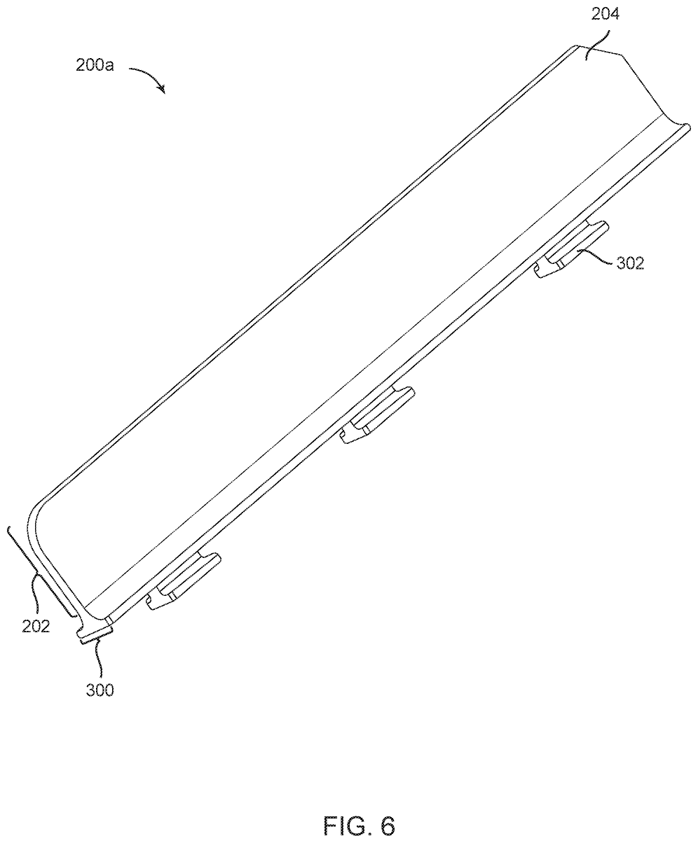

Looking now at FIG. 6, system 100 comprises at least one partition 200a-n for segregating lures 1012, 1014 on the cards 102a-n, FIG. 2 illustrates a perspective view of a card 102a, showing multiple partitions 200a-n, coupled thereto. Those skilled in the art will recognize that the gripping/tangling potential of fishing hooks may cause adjacent lures to tangle. Thus, partition 200a-n serves as a segregation means to maintain each lure in an individual vertical channel while being retained on the cards 102a-n. In one embodiment, partition is defined by a front side 202, comprising an elongated panel 204. The elongated configuration of panel 204 allows for substantially all of card 102a to be segregated from the top edge 112 to the bottom edge 110.

Partition 200a-n also has an opposing rear side 300. As FIG. 7A illustrates, rear side 300 of partitions 200a-n comprises a tapered connector 700 and a flange 302. In some embodiments, flange 302 may be tapered, as shown in FIG. 7C. Tapering of flange 302 may be at angle B°, where angle B is an acute angle. The terminus of flange may also be rounded at radian C to facilitate slidable coupling into tapered card-holes 114a-n (See FIG. 7C).

FIG. 7B is a close-up of a frontal cross-sectional of the tapered connector and flange, taken generally along line B-B in FIG. 7C. Tapered connecter 700 serves as a nexus between card front face 106 and flange 302. The tapered or narrowing shape of tapered connector 700 allows for a snug fit with tapered card-holes 114a-n in cards 102a-n (See FIG. 5). In one non-limiting embodiment shown in FIG. 7B, tapered connector 700 may be at angle A°.

Also, flange 302 is sized and dimensioned to mate with tapered card-holes 114a-n and tapered connector 700 is tapered at an angle A°, where angle A is an acute angle. Rear side 300 of partition 200a is detachably attachable to the card in a perpendicular relationship. FIG. 7C shows a close-up of a side view of the tapered connector 700 and flange 302. FIG. 7C shows tapering of flange 302 at angle B°, where angle B° is an acute angle. In summary, acute angle A° is designed to create a friction-fit coupling effect between tapered connector 700 and corresponding tapered card holes 114a-n and acute angle B° is designed to create a friction-fit coupling effect between flange 302 and the rear side 300 of the card.

In one exemplary coupling effect, flange 302 engages the tapered card-holes 114a-n in a snug, slidable relationship. For example, flange passes through tapered card-hole, and then slides into narrowing shape thereof, matching tapered shape of flange to form a snug fit there between. In this manner, the at least one partition 200a-n segregates the card into multiple vertical channels.

However, in alternative embodiments, partition does not utilize a flange and tapered connector to couple with cards. Rather, the rear side 300 of partition 200a comprises a tapered base 800, 900 for coupling to a dovetail that positions across the cards. The use of such a tapered base is ideal when the dovetail design is used with card 102a having tapered card-holes 114a-n. This is because the shapes are similar, and create a friction-fit, slidable coupling effect.

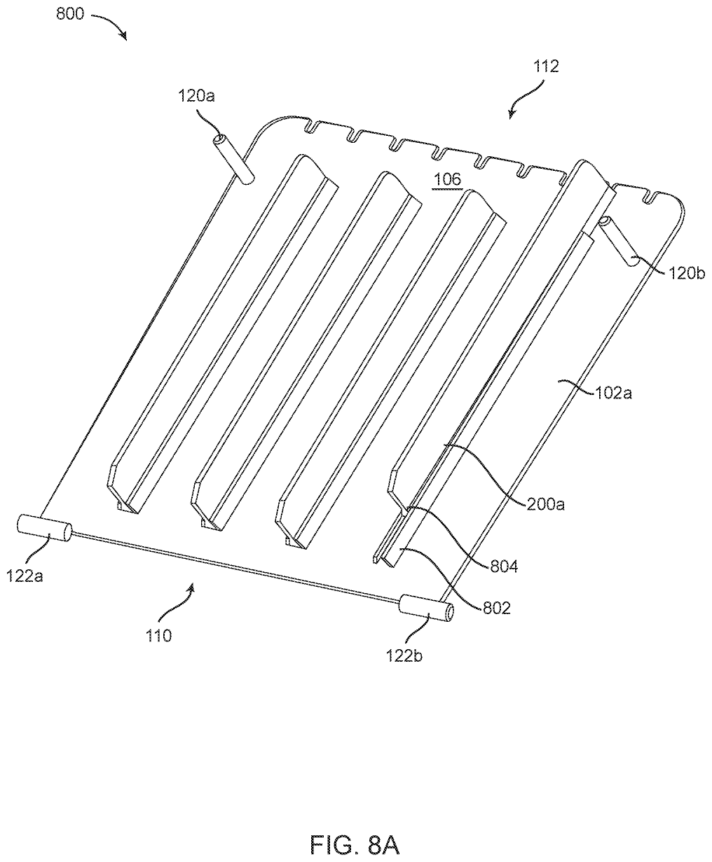

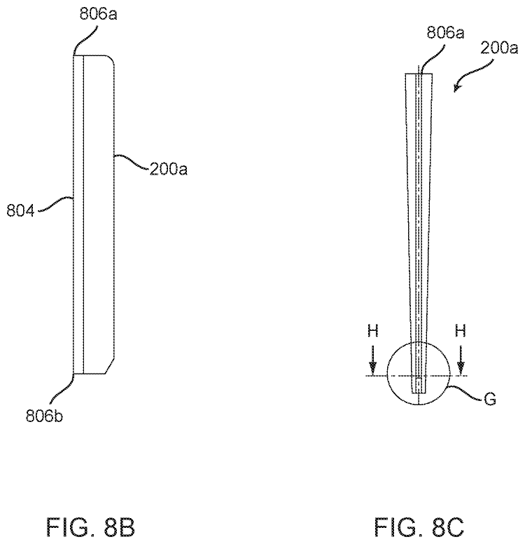

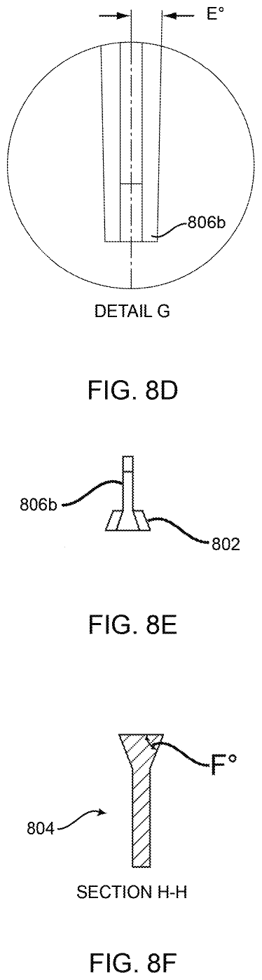

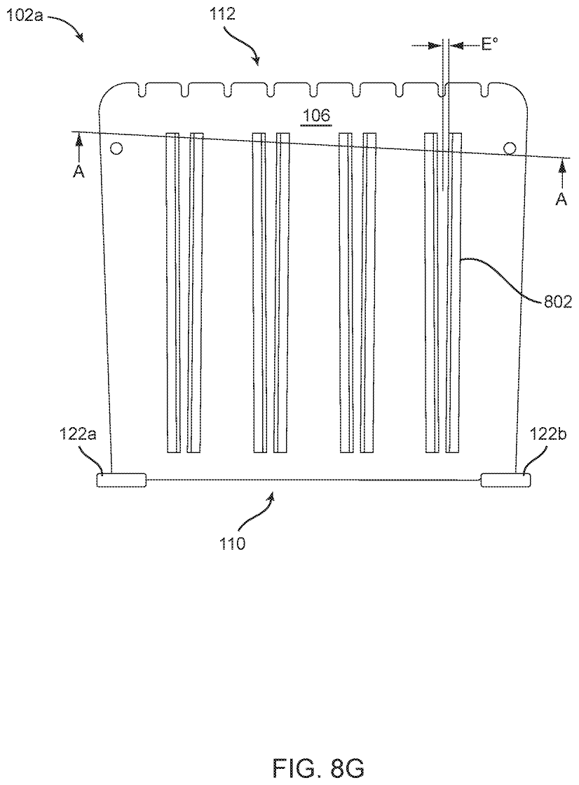

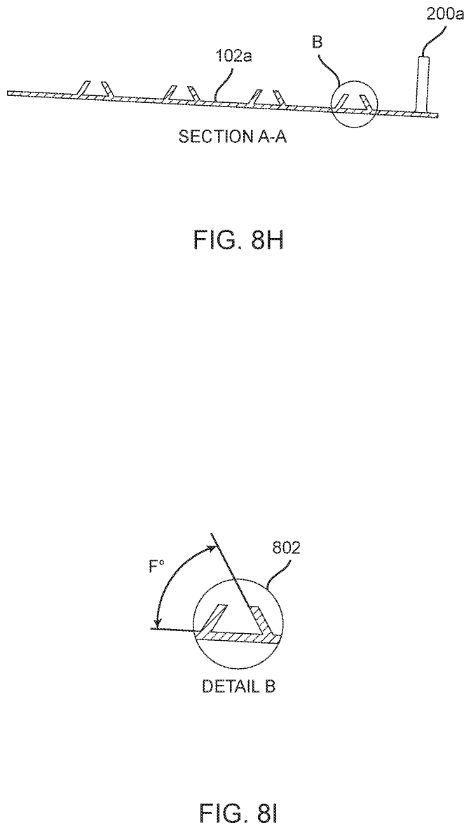

FIGS. 8A-8I illustrate an alternative embodiment of a card 800 and a corresponding tapered partition 804 configured to join together through a single, elongated tapered dovetail joint 802. Tapered dovetail joint 802 extends fully, and in a non-parallel configuration, from the top edge 112 to the bottom edge 110 of card 800, so as to enable slidable mating with corresponding tapered partition 804. The divergence of tapered dovetail joint 802 allows partition to easily enter wide end, and compress into narrow end, so as to create the snug fit between partition and dovetail joint 802.

As illustrated, front face of card 800 carries tapered dovetail joint 802 in a non-parallel configuration extending across the front face 106 of card 800, running from a wide angle to a narrow angle. In some embodiments, the variance between opposing edges of dovetail joint 802 may be less than 3°. In one non-limiting embodiment, the tapered partition is defined by a wide end 806a mating with a wide section of the top edge 112; and a narrow end 806b mating with a narrow section of the bottom edge 110 of the card 800.

FIG. 8B shows an elevated side view of the partition having a wide end and a narrow end corresponding to the wide and narrow angles of the tapered dovetail joint 802. This tapered arrangement creates a snug relationship that holds the tapered partition in the perpendicular placement on the card 800. Continuing with the alternative embodiment, FIG. 8C shows a frontal view of the tapered partition 804 having a wide end 806a and a narrow end 806b, where FIG. 8D shows the narrow end of the tapered partition 804.

The junction between the narrow end of the tapered junction and the tapered dovetail joint is illustrated in FIG. 8E. In yet another illustration, FIG. 8F shows a cross-sectional of tapered dovetail joint 802 at an angle of F°, taken generally along line H-H in FIG. 8C of the tapered partition. Angle F° is defined as an acute angle that is sloped, such that the tapered dovetail joint snugly receives the tapered partition—60° for example.

Continuing with the alternative card 800, FIG. 8G shows a front view of card 800 with multiple tapered dovetail joints extending across the front face. Each tapered dovetail joint is configured in a non-parallel arrangement from narrow to wide sections, so as to accommodate a corresponding tapered partition. Thus, the tapered dovetail joint 802 can be wider at the top edge of the card, and narrower in relation, at the bottom edge of card 800. In another view, FIG. 8H shows a cross-sectional of the card, taken generally along line A-A in FIG. 8G. This illustrates the slope of the angles, which creates a snug fit with tapered partition, as shown in FIG. 8I.

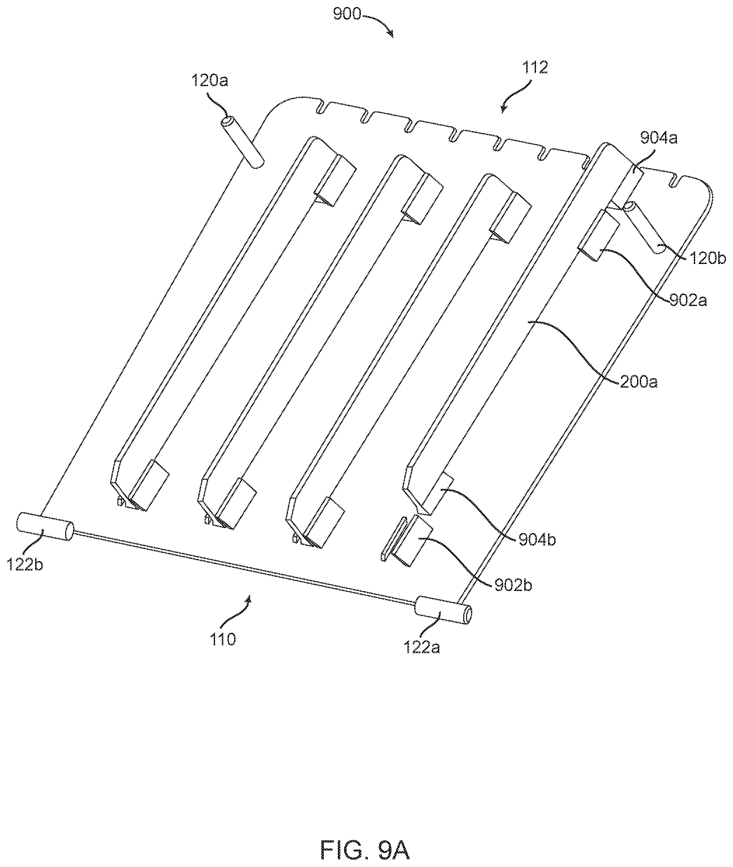

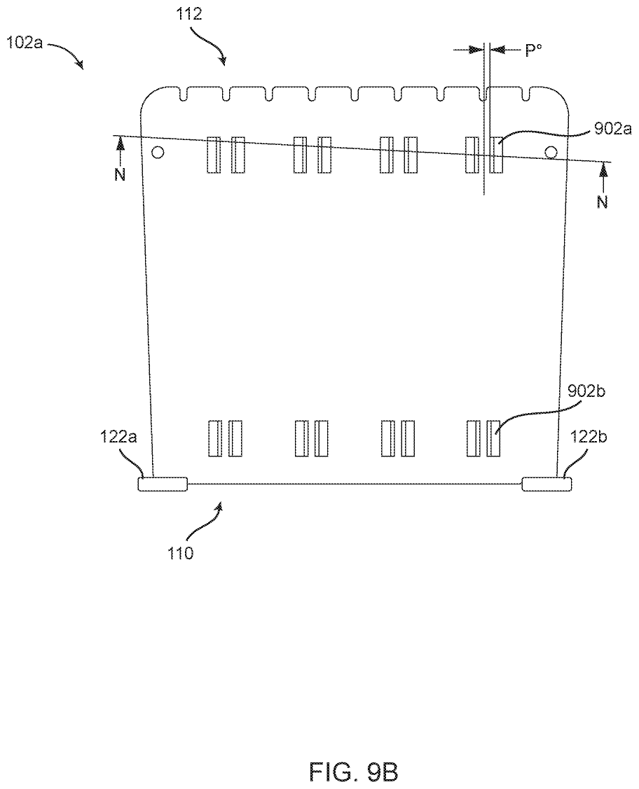

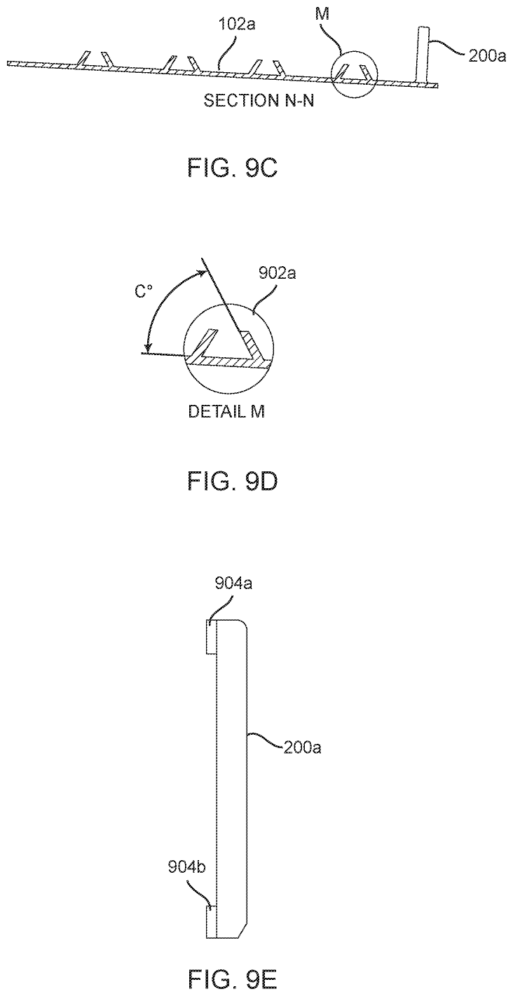

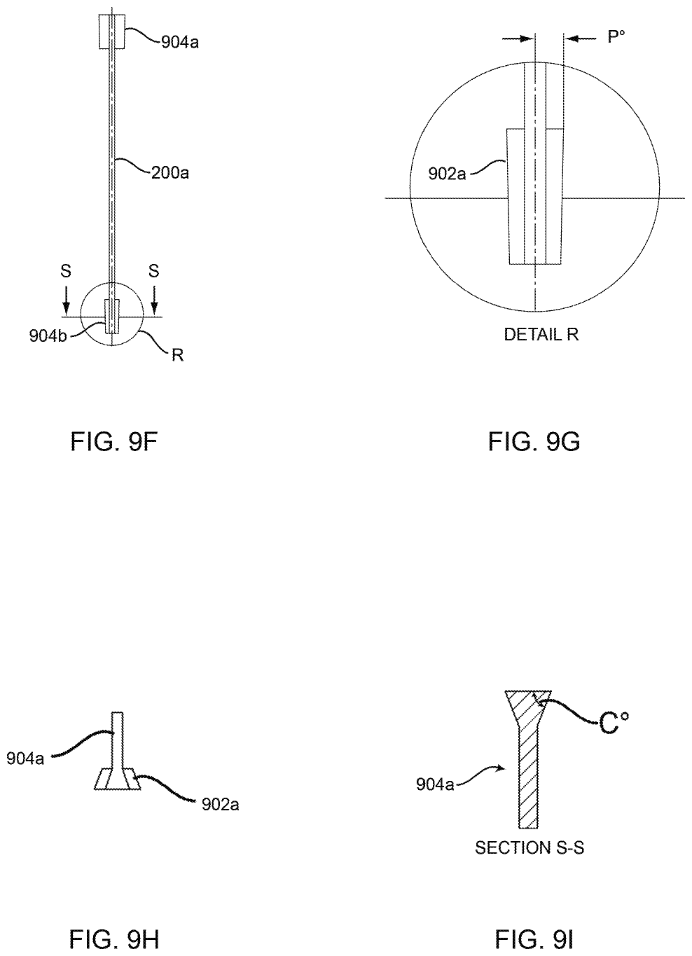

In yet another alternative embodiment, a card 900 may have substantially the same structure as card 800, but with separated tapered dovetails 902a, 902b at opposing edges 112, 110 of card 900. As FIG. 9A shows, separated tapered dovetails 902a-b are separated into a wide tapered dovetail 902a at the top edge 112 of card 900, and a narrow-tapered dovetail 902b at the bottom edge 110 of card 900. In this alternative configuration, a tapered partition 200a having a wide section 904a that slidably mates with wide tapered dovetail 902a and a narrow section 904b that slidably mates with narrow tapered dovetail 902b for coupling thereto. The difference in angles, from a wide end to a narrow end, creates a snug fit for more stable fastening of tapered partition 200a to card 900.

A top view of card 900 in FIG. 9B shows card 900 having wide tapered dovetail 902a oriented at top edge 112, and narrow-tapered dovetail 902b at opposing bottom edge 110. This variance in angles enables secure coupling to a corresponding tapered partition. Further illustrations at FIG. 9C show a cross-sectional of card 900, taken generally along line N-N in FIG. 9B. The angle of tapered dovetails is clearly shown. In a more detailed view, FIG. 9D shows separated tapered dovetail joint 902a from FIG. 9C at an angle of C°. In one non-limiting embodiment, angle C° is defined as an acute angle that is sloped, such that wither wide or narrow separated tapered dovetail 902a-b snugly receives the tapered partition—60° for example.

Continuing with card 900, FIG. 9E shows an elevated side view of the partition having a wide end and a narrow end, FIG. 9F shows a frontal view of the tapered partition. Further, FIG. 9G shows a narrow end of the tapered partition at an angle of P°. In one non-limiting embodiment, angle P° is defined as an acute angle that is sloped, such that both separated tapered dovetails snugly receive tapered partition. Angle P° may be sloped at various angles operable to create a snug fit therebetween.

For example, FIG. 9H shows the junction between narrow end of the tapered junction and the separated tapered dovetail joint, and FIG. 9I shows a cross-sectional of separated narrow-tapered dovetail 902b, taken generally along line S-S in FIG. 9F of separated tapered partition 200a. In either dovetail junction configuration on cards 800, 900, the quick detachable attachment with corresponding partitions is possible—similar to the aforementioned tapered card-holes 114a-n in FIG. 5.

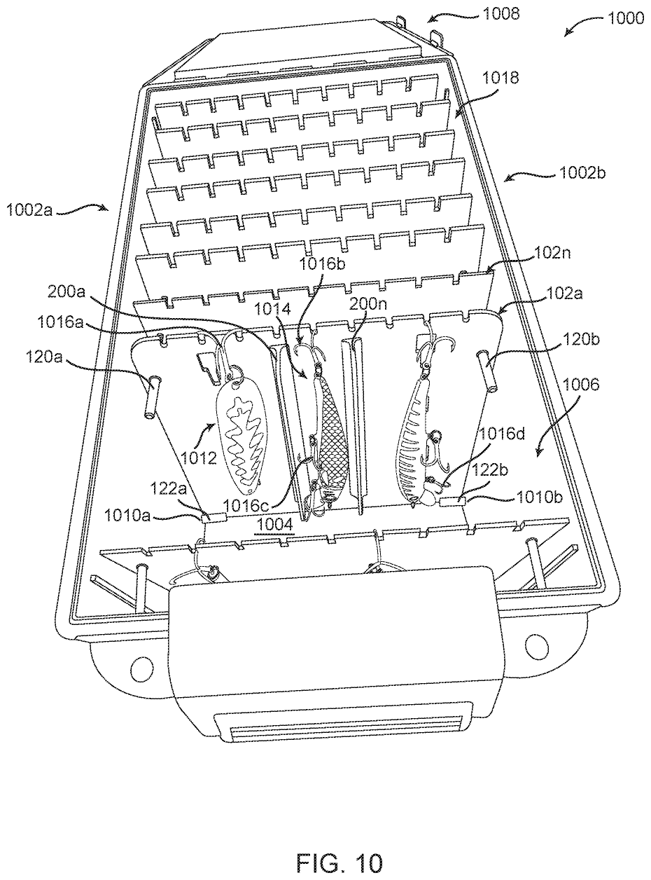

Turning now to FIG. 10, cards 102a-n are pivotably operable in the cavity of a container 1000, whereby the cards operate like individual cards in a card-file organizer. In some embodiments, container 1000 may include, without limitation, a fishing tackle box, terminal tackle kit, a hook kit, a tool box, and any container used to retain items that have hooks, or other components with a tendency to tangle. The use of the cards 102a-n as organization/segregation means, inside a fishing tackle box is a useful concept, since hooks, lines, and other potentially tangling components are located inside a fishing tackle box.

In one possible embodiment, container 1000 is rectangular-shaped, and defined by sidewalls 1002a-b, a floor wall 1004, an opening 1018, and a lid 1008 that regulates access to the opening, the sidewalls 1002a-b and the floor wall 1004 forming a cavity 1006. Cards 102a-n are operable in the cavity 1006 of the container 1000 to swivel in two directions while pivotably coupled to the apertures 1010a, 1010b in the sidewalls 1002a-b of the container 1000.

Looking back at the cards 102a-n, the at least one axle 122a, 122b that extends laterally, and coplanar from the side edges 108a, 108b of the card pivotally couples with the container 1000 to enable the pivoting therebetween. This is because the sidewalls 1002a-b of the container 1000 are defined by multiple apertures 1010a, 1010b sized and dimensioned to receive the at least one axle 122a, 122b in a pivoting relationship. Thus, axle 122a, 122b mates with holes in the side of the tackle box, which allows the card to swivel on an axis in the inner surface of the tackle box, so as to provide an angled view and an easy access of the lure, while also retaining the card in a vertical, upright position.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A fishing lure storage and organization system, the system comprising:
multiple cards defined by a front face, a rear face, a pair of side edges, a top edge, and an opposing bottom edge, the top edge forming multiple, spaced-apart niches, the faces forming multiple tapered card-holes disposed in an aligned, vertical arrangement from the top edge to the bottom edge; at least one spacer extending perpendicularly from the front face of the card;
at least one axle extending laterally, and coplanar from the side edges of the card; and
at least one partition comprising an elongated panel defined by a front side and an opposing rear side, the rear side being detachably attachable to the tapered card-holes of the card in a perpendicular relationship,
whereby the at least one partition segregates the card into multiple vertical channels.

2. The system of claim 1, wherein the cards are defined by a flat, rectangular shape.

3. The system of claim 1, wherein the niches are sized and dimensioned to retain a primary hook from a spoon, or a crankbait, or both.

4. The system of claim 1, wherein the tapered card-holes are defined by a wide end and narrow end.

5. The system of claim 1, wherein the at least one spacer comprises two elongated, cylindrical-shaped tabs.

6. The system of claim 1, wherein the rear side of the at least one partition comprises a tapered connector and a flange, the flange being sized and dimensioned to mate with the tapered card-holes.

7. The system of claim 6, wherein the flange engages the tapered card-holes in a snug, slidable relationship.

8. The system of claim 1, wherein the at least one axle extends laterally, and coplanar from the side edges of the card, proximal to the bottom edge of the sidewalls.

9. The system of claim 8, wherein the at least one axle comprises a pair of opposing, elongated cylinders.

10. The system of claim 1, further comprising a container defined by sidewalls, a floor wall, an opening, and a lid regulating access to the opening, the sidewalls and the floor wall forming a cavity.

11. The system of claim 10, wherein the sidewalls of the container are defined by multiple apertures sized and dimensioned to receive the at least one axle in a pivoting relationship.

12. The system of claim 11, wherein the cards are operable in the cavity of the container to swivel in two directions while pivotably coupled to the apertures in the sidewalls of the container.

13. The system of claim 1, further comprising multiple tapered dovetail junctions extending from the top edge to the bottom edge, the tapered dovetail junctions arranged in a non-parallel configuration.

14. A fishing lure storage and organization system, the system comprising:
multiple cards defined by a front face, a rear face, a pair of side edges, a top edge, and an opposing bottom edge, the top edge forming multiple, spaced-apart niches, the faces further forming a dovetail at least partially across the front face of the card, the dovetail being oriented from the top edge to the bottom edge; at least one spacer extending perpendicularly from the front face of the card; at least one axle extending laterally, and coplanar from the side edges of the card; and
at least one partition comprising an elongated panel defined by a front side and an opposing rear side, the rear side being detachably attachable to the dovetail of the card in a perpendicular relationship,
whereby the at least one partition segregates the card into multiple vertical channels.

15. The system of claim 14, wherein the rear side of the at least one partition comprises a tapered base, the tapered base being sized and dimensioned to slidably mate with the dovetail.

16. The system of claim 15, wherein the tapered base engages the dovetail in a snug, slidable relationship.

17. The system of claim 16, wherein the at least one axle extends laterally, and coplanar from the side edges of the card, proximal to the bottom edge of the sidewalls.

18. The system of claim 17, further comprising a container defined by sidewalls, a floor wall, an opening, and a lid regulating access to the opening, the sidewalls and the floor wall forming a cavity, the sidewalls being defined by multiple apertures sized and dimensioned to receive the at least one axle in a pivoting relationship.

19. A fishing lure storage and organization system, the system comprising:
multiple cards defined by a front face, a rear face, a pair of side edges, a top edge, and an opposing bottom edge, the top edge forming multiple, spaced-apart niches, the faces forming multiple tapered card-holes disposed in an aligned, vertical arrangement from the top edge to the bottom edge; at least one spacer extending perpendicularly from the front face of the card;
at least one axle extending laterally, and coplanar from the side edges of the card;
at least one partition comprising an elongated panel defined by a front side and an opposing rear side, the rear side being detachably attachable to the tapered card-holes of the card in a perpendicular relationship,
whereby the at least one partition segregates the card into multiple vertical channels; and
a container defined by sidewalls, a floor wall, an opening, and a lid regulating access to the opening, the sidewalls and the floor wall forming a cavity, the sidewalls being defined by multiple apertures sized and dimensioned to receive the at least one axle in a pivoting relationship.

20. The system of claim 19, wherein the cards are operable in the cavity of the container to swivel in two directions while pivotably coupled to the apertures in the sidewalls of the container.
